(19) United States
(12) Patent Application Publication
(10) Pub. No.: US 2023/0204837 A1
(43) Pub. Date: Jun. 29, 2023

(54) GLARE REDUCTION SYSTEM

(71) Applicant: MILWAUKEE ELECTRIC TOOL CORPORATION, Brookfield, WI (US)

(72) Inventors: James Wekwert, Wauwatosa, WI (US); Scott T. Moeller, Richfield, WI (US); Michael A. Verhagen, Nashotah, WI (US)

(21) Appl. No.: 17/923,453

(22) PCT Filed: May 5, 2021
(86) PCT No.: PCT/US2021/030833

§ 371 Date: Nov. 7, 2022

Related U.S. Application Data
(60) Provisional application No. 63/020,701, filed on May 6, 2020.

(51) Int. Cl. G02B 5/30; G02C 7/12; B60J 3/06; F21S 41/135

(52) U.S. Cl. CPC G02B 5/30; G02C 7/12; B60J 3/06; F21S 41/135; F21Y 2115/10

(57) ABSTRACT

A glare reduction system includes a light source, a first circular polarizing filter, and a pair of second circular polarizing filters. The first circular polarizing filter is positioned to receive light from the light source. The first circular polarizing filter is able to pass light that is polarized in a first circular direction. The second circular polarizing filters include respective portions positioned laterally from one other. The pair of second circular polarizing filters is located a distance from the first circular polarizing filter. Each of the pair of second circular polarizing filters is able to pass light that is polarized in a second circular direction. The second circular direction is opposite the first circular direction

### CROSS-REFERENCE TO RELATED APPLICATIONS

This application claims the benefit of U.S. Provisional Patent Application No. 63/020,701, filed May 6, 2020, the entire contents of which are hereby incorporated by reference.

### FIELD

The present disclosure relates to the reduction of glare using one or more polarizing light filters.

### SUMMARY

The present disclosure relates, in some aspects, to a glare reduction system. The glare reduction system includes a light source, a first circular polarizing filter, and a pair of second circular polarizing filters. The first circular polarizing filter is positioned to receive light from the light source. The first circular polarizing filter is able to pass light that is polarized in a first circular direction. The second circular polarizing filters include respective portions positioned laterally from one other. The pair of second circular polarizing filters is located a distance from the first circular polarizing filter. Each of the pair of second circular polarizing filters is able to pass light that is polarized in a second circular direction. The second circular direction is opposite the first circular direction

The present disclosure relates, in some aspects, to a glare reduction system. The glare reduction system includes a pair of light sources, a pair of first circular polarizing filters, and a second circular polarizing filter. The light sources are positioned laterally from each other. The first circular polarizing filters include respective portions positioned laterally from one another. Each of the pair of first circular polarizing filters is positioned to receive light from a respective one of the pair of light sources. Each of the pair of first circular polarizing filters is able to pass light that is polarized in a first circular direction. The second circular polarizing filter is located a distance from the pair of first circular polarizing filters. The second circular polarizing filter is able to pass light that is polarized in a second circular direction. The second circular direction is opposite the first circular direction.

The present disclosure relates, in some aspects, to a glare reduction system. The glare reduction system includes a vehicle, a pair of first circular polarizing filters, and a second circular polarizing filter. The vehicle includes a pair of headlights and a windshield. Each of the pair of first circular polarizing filters is positioned to receive light from a respective one of the headlights. Each of the pair of first circular polarizing filters is able to pass light that is polarized in a first circular direction. The second circular polarizing filter is positioned over the windshield. The second circular polarizing filter is able to pass light that is polarized in a second circular direction. The second circular direction is opposite the first circular direction.

The present disclosure relates, in some aspects, to a glare reduction system. The glare reduction system includes a light source, a first circular polarizing filter, and an eye shield. The first circular polarizing filter is positioned to receive light from the light source. The first circular polarizing filter is able to pass light that is polarized in a first circular direction. The eye shield includes a first eye section and a second eye section. The eye shield includes a second circular polarizing filter disposed over both the first eye section and the second eye section. The second circular polarizing filter is able to pass light that is polarized in a second circular direction. The second circular direction is opposite the first circular direction.

Features and aspects of the disclosure will become apparent by consideration of the following detailed description and accompanying drawings.

### BRIEF DESCRIPTION OF THE DRAWINGS

FIG. 1 is a schematic illustration of a glare reduction system according to embodiments disclosed herein.

FIG. 2 is a front elevation view of a light source of the glare reduction system of FIG. 1.

FIG. 3 is a front elevation view of a pair of glasses of the glare reduction system of FIG. 1.

FIG. 4 is a schematic illustration of a glare reduction system according to embodiments disclosed herein.

FIG. 5 is a schematic illustration of a glare reduction system according to embodiments disclosed herein.

FIG. 6 is a perspective view of a pair of goggles for use with a glare reductions system according to embodiments disclosed herein.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

Embodiments disclosed herein utilize one or more circular polarizing filters, also known as circular polarizers. These circular polarizing filters can be used to block some light and pass other light. Depending on the construction of the circular polarizing filter, the light that is passed can be either clockwise circularly polarized light or counter-clockwise circularly polarized light.

Although there are many ways to circularly polarize light, one inexpensive embodiment includes utilizing a linear polarizing filter and a quarter-wave plate. The quarter-wave plate is placed downstream of the linear polarizing filter. Unpolarized light can encounter the linear polarizing filter, which results in linear polarized light passing the linear polarizing filter. This linear polarized light then encounters the quarter-wave plate. The quarter-wave plate can have, for instance, a horizontal slow axis and a vertical fast axis. When light travels through the quarter-wave plate, the horizontal component of the light lags behind the vertical component of the light. Upon leaving the quarter-wave plate, the light has its horizontal component behind (or out of phase with) the vertical component by a quarter of the wavelength of the light.

In this simplified explanation, as the light travels along a general direction, the wave of the horizontal component of the light is at its peak while the wave of the vertical component of the light is at the longitudinal axis of the general direction. The resultant wave vector of the light is one that rotates about the longitudinal axis as the light moves forward.

If this circularly polarized light is, for instance, clockwise circularly polarized, a counter-clockwise circular polarizing filter would block all, or nearly all, of the clockwise circularly polarized light. This phenomenon is present regardless of the rotational position of the filter, as long as the filter is facing the incoming light. If any unpolarized light encounters the counter-clockwise circular polarizing filter, counter-clockwise circularly polarized light would pass the filter.

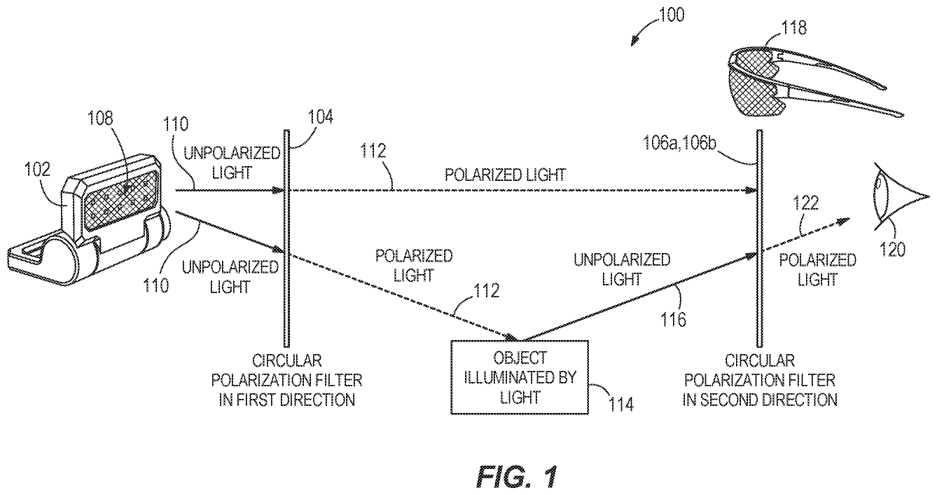

With reference to FIG. 1, an embodiment of a glare reduction system 100 is shown. The glare reduction system 100 includes a light source 102, a first circular polarizing filter 104, and a pair of second circular polarizing filters 106a, 106b.

In the illustrated embodiment, the light source 102 is a work light, although other light sources are contemplated herein. In some embodiments, the work light includes an array of light-emitting diodes (LEDs) 108. The array of LEDs 108 are configured to emit unpolarized light 110 in the visible spectrum to illuminate a work area. The work light 102 may include, for instance, a battery-powered work light. Other embodiments may include a light source 102 that is plugged in to a mains power source.

The glare reduction system 100 further includes the first circular polarizing filter 104 positioned to receive the unpolarized light 110 from the light source 102. In some embodiments, the first circular polarizing filter 104 is positioned to receive all or substantially all of the unpolarized light 110 from the light source 102.

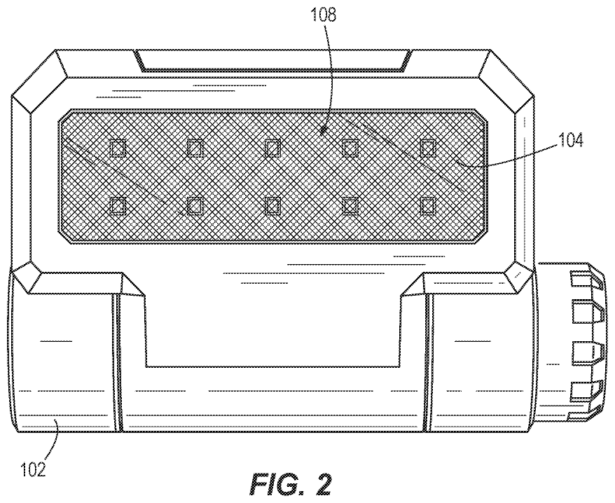

As shown in FIG. 2, the illustrated embodiment includes the first circular polarizing filter 104 coupled to the light source 102 and covering the array of LEDs 108. The first circular polarizing filter 104 may be permanently affixed to a housing of the light source 102, an outer surface of a lens of the light source 102, an inner surface of the lens of the light source 102, disposed within a lens of the light source 102, or the like. Further, the first circular polarizing filter 104 may be removably coupled to the housing of the light source 102, the lens of the light source 102, or the like.

With continued reference to FIG. 1, the first circular polarizing filter 104 is configured to block some of the unpolarized light 110 and pass circularly polarized light 112 in a first circular direction. The first circular direction of the circularly polarized light 112 may be either clockwise or counter-clockwise. Stated another way, the first circular polarizing filter 104 may be a clockwise circular polarizing filter or a counter-clockwise circular polarizing filter.

The circularly polarized light 112 in the first circular direction (whether it is clockwise or counter-clockwise) illuminates a work area in a similar range as would occur with a typical light source 102 having no first circular polarizing filter 104. Some of the circularly polarized light 112 travels directly to the second circular polarizing filters 106a, 106b (discussed more below), and some of the circularly polarized light 112 travels to one or more objects 114 in the work area. The one or more objects 114 in the work area may include, for instance, a work surface, a floor, a tool, a person, a wall, or the like. At least some of the circularly polarized light 112 is reflected off of the one or more objects 114, resulting in at least some unpolarized light 116 being directed away from the one or more objects 114, thereby illuminating the one or more objects 114. The more reflective an object 114 is, however, less unpolarized light 116 is produced. As such, reflective objects 114 would change the direction of the circularly polarized light.

The pair of second circular polarizing filters 106a, 106b are located remotely (e.g., at a distance) from the first circular polarizing filter 104. The pair of second circular polarizing filters 106a, 106b are positioned laterally from each other, such that each of the pair of second circular polarizing filters 106a, 106b is able to receive light 112, 116. Stated another way, the pair of second circular polarizing filters 106a, 106b are not stacked on top of each other such that one of the filters 106a, 106b is downstream from the other of the filters 106a, 106b. In some embodiments, the pair of second circular polarizing filters 106a, 106b are discrete from one another, in that no portions of the second circular polarizing filters 106a, 106b overlap. In other embodiments, however, at least a portion of one of the second circular polarizing filters 106a, 106b overlaps with another of the second circular polarizing filters 106a, 106b. In the illustrated embodiment, the second circular polarizing filters 106a, 106b are part of a pair of glasses 118, such as safety glasses or sunglasses. Other embodiments may include the second circular polarizing filters 106a, 106b being part of a pair of goggles, a face mask, a hood, a barrier, a vehicle, or the like.

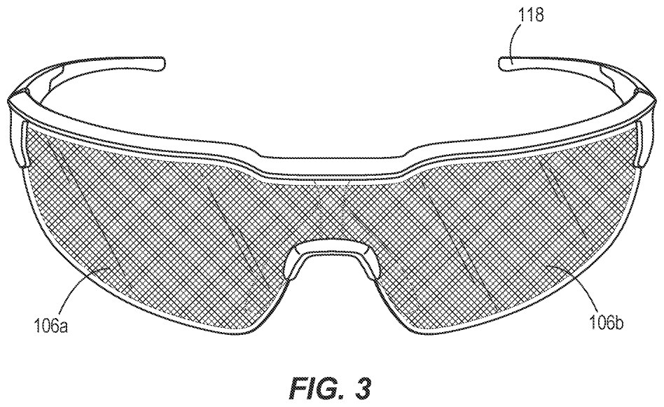

As shown in FIG. 3, the pair of glasses 118 includes the pair of second circular polarizing filters 106a, 106b such that each of the second circular polarizing filters 106a, 106b is positioned over a respective one of a user's eyes 120 (shown schematically in FIG. 1). In some embodiments, each of the second circular polarizing filters 106a, 106b is permanently affixed to a frame of the pair of glasses 118, to an outer surface of a respective lens of the pair of glasses 118, to an inner surface of a respective lens of the pair of glasses 118, disposed within a respective lens of the pair of glasses 118, or the like. In other embodiments, each of the second circular polarizing filters 106a, 106b is removably coupled to the frame of the pair of glasses 118, a respective lens of the pair of glasses 118, or the like.

With continued reference to FIG. 1, each of the second circular polarizing filters 106a, 106b is configured to pass circularly polarized light 122 in a second circular direction. The second circular direction of the circularly polarized light 122 may be either clockwise or counter-clockwise, but it is the opposite direction of the first circular direction of the circularly polarized light 112. Stated another way, the second circular polarizing filters 106a, 106b may be clockwise circular polarizing filters (if the first circular polarizing filter 104 is a counter-clockwise circular polarizing filter), or the second circular polarizing filters 106a, 106b may be counter-clockwise circular polarizing filters (if the first circular polarizing filter 104 is a clockwise circular polarizing filter). In this manner, all or substantially all of the circularly polarized light 112 in the first circular direction received from the light source 102 and first circular polarizing filter 104 is blocked by each of the second circular polarizing filters 106a, 106b to prevent excessive glare from reaching the user's eyes 120. Illumination of objects 114 in the workspace, however, is detected by the user's eyes 120 due to the fact that circularly polarized light 122 in the second circular direction reaches the user's eyes 120, because each of the second circular polarizing filters 106a, 106b is configured to block some of the unpolarized light 116 and pass circularly polarized light 122 in the second circular direction.

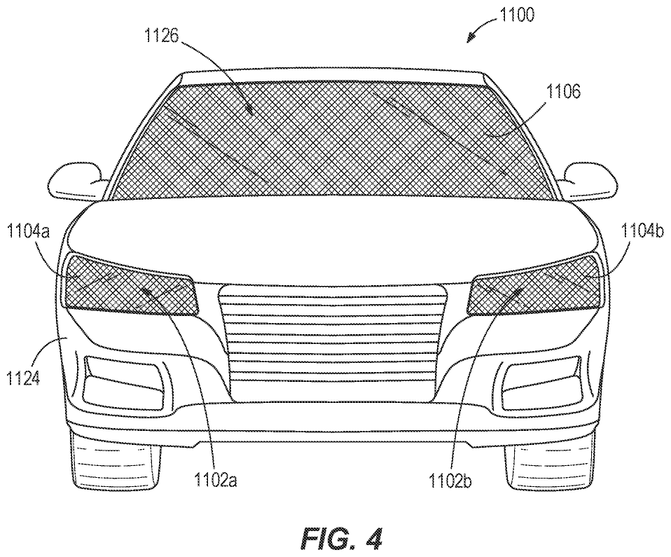

As shown in FIG. 4, the present disclosure contemplates another embodiment of a glare reduction system 1100. Similar elements between the previously discussed glare reduction system 100 and the glare reduction system 1100 of FIG. 4 are given the same reference number, but increased by a value of one thousand. Only differences between the glare reduction system 100 of FIG. 1 and the glare reduction system 1100 of FIG. 4 will be discussed herein in the interest of brevity.

The glare reduction system 1100 includes a pair of light sources 1102a, 1102b, a pair of first circular polarizing filters 1104a, 1104b, and a second circular polarizing filter 1106.

In the illustrated embodiment, the pair of light sources 1102a, 1102b are positioned laterally from each other, such that the light projected by the pair of light sources 1102a, 1102b does not completely overlap. Stated another way, the pair of light sources 1102a, 1102b are not aligned successively such that one light source 1102a, 1102b is not entirely downstream of the other light source 1102a, 1102b. In the illustrated embodiment, the pair of light sources 1102a, 1102b is a pair of headlights coupled to, for instance, a vehicle 1124. Other light sources are contemplated herein, however. In some embodiments the light sources 1102a, 1102b are LED light sources, but other embodiments may include halogen light sources, xenon light sources, some combination thereof, or the like.

The glare reduction system 1100 further includes each of the pair of first circular polarizing filter 1104a, 1104b positioned to receive unpolarized light from a respective one of the pair of light sources 1102a, 1102b. In some embodiments, each of the pair of first circular polarizing filters 1104a, 1104b is positioned to receive all or substantially all of the unpolarized light from the respective one of the pair of light sources 1102a, 1102b. Each of the pair of first circular polarizing filters 1104a, 1104b may be permanently affixed to a housing of the respective light source 1102a, 1102b, an outer surface of a lens of the respective light source 1102a, 1102b, an inner surface of the lens of the respective light source 1102a, 1102b, disposed within a lens of the respective light source 1102a, 1102b, another portion of the vehicle 1124, or the like. Further, each of the first circular polarizing filters 1104a, 1104b may be removably coupled to the housing of the respective light source 1102a, 1102b, the lens of the respective light source 1102a, 1102b, another portion of the vehicle 1124, or the like.

Each of the first circular polarizing filters 1104a, 1104b is configured to block some of the unpolarized light emitted by the respective light source 1102a, 1102b and pass circularly polarized light in a first circular direction. The first circular direction of the circularly polarized light may be either clockwise or counter-clockwise. Stated another way, each of the first circular polarizing filters 1104a, 1104b may be a clockwise circular polarizing filter or a counter-clockwise circular polarizing filter.

The glare reduction system 1100 further includes the second circular polarizing filter 1106 disposed on the vehicle 1124. In the illustrated embodiment, the second circular polarizing filter 1106 is positioned over the windshield 1126 of the vehicle 1124. The second circular polarizing filter 1106 may be permanently affixed to a frame of the vehicle 1124, an outer surface of the windshield 1126, an inner surface of the windshield 1126, disposed within the windshield 1126, another portion of the vehicle 1124, or the like. Further, the second circular polarizing filter 1106 may be removably coupled to the frame of the vehicle 1124, the windshield 1126, another portion of the vehicle 1124, or the like.

The second circular polarizing filter is configured to pass circularly polarized light in a second circular direction. The second circular direction of the circularly polarized light may be either clockwise or counter-clockwise, but it is the opposite direction of the first circular direction of the circularly polarized light. Stated another way, the second circular polarizing filter may be a clockwise circular polarizing filter (if the first circular polarizing filters 104 are counter-clockwise circular polarizing filters), or the second circular polarizing filter may be a counter-clockwise circular polarizing filter (if the first circular polarizing filters are clockwise circular polarizing filters).

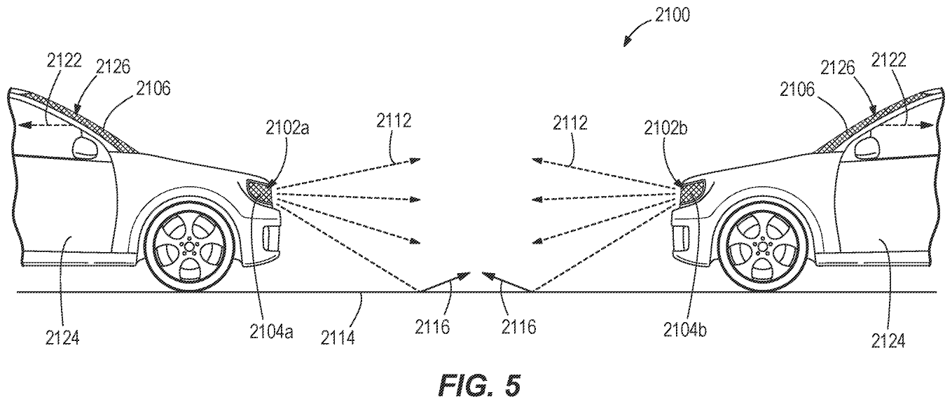

As shown in FIG. 5, the present disclosure contemplates another embodiment of a glare reduction system 2100. Similar elements between the previously discussed glare reduction system 100 and the glare reduction system 2100 of FIG. 5 are given the same reference number, but increased by a value of two thousand. Similar elements between the previously discussed glare reduction system 1100 and the glare reduction system 2100 of FIG. 5 are given the same reference number, but increased by a value of one thousand. Only differences between the glare reduction systems 100, 1100 and the glare reduction system 2100 of FIG. 5 will be discussed herein in the interest of brevity.

The glare reduction system 2100 includes a pair of light sources 2102a, 2102b, a pair of first circular polarizing filters 2104a, 2104b, and a second circular polarizing filter 2106. The pair of light sources 2102a, 2102b are positioned laterally from each other, such that the light projected by the pair of light sources 2102a, 2102b does not completely overlap. Stated another way, the pair of light sources 2102a, 2102b are not aligned successively such that one light source 2102a, 2102b is not entirely downstream of the other light source 2102a, 2102b. The second circular polarizing filter 2106 is located remotely (e.g., at a distance) from the first circular polarizing filters 2104a, 2104b.

The illustrated embodiment includes two vehicles 2124. Each vehicle includes a pair of light sources 2102a, 2102b, although only one of the pair of light sources 2102a, 2102b is shown on each of the vehicles 2124 due to the orientation of the vehicles 2124. As discussed above, each of a pair of first circular polarizing filters 2104a, 2104b is located downstream from the respective one of the light sources 2102a, 2102b. Unpolarized light emitted by each light source 2102a, 2102b is filtered by the respective first circular polarizing filter 2104a, 2104b. Circularly polarized light 2112 in the first circular direction passes the first circular polarizing filters 2104a, 2104b. All or substantially all of this circularly polarized light 2112 in the first circular direction is blocked by the second circular polarizing filter 2106 (illustrated as disposed over the windshield 2126 of the vehicle 2124). An object, such as a road, 2114 may receive the circularly polarized light 2112 in the first circular direction. The object 2114 is, therefore illuminated, and unpolarized light 2116 travels from the object 2114. The unpolarized light 2116 is filtered by the second circular polarizing filter 2106, and the second circular polarizing filter 2106 passes circularly polarized light 2122 in the second circular direction.

Although both vehicles 2124 are equipped with a pair of first circular polarizing filters 2104a, 2104b as well as a second circular polarizing filter 2106, some embodiments may include only one vehicle 2124 having the pair of first circular polarizing filters 2104a, 2104b and only the other vehicle 2124 having the second circular polarizing filter 2106. Further, although vehicles 2124 are discussed above with regard to FIG. 5, other embodiments may include a pair of light sources 2102a, 2102b that are not associated with a vehicle, such as a pair of work lights, a pair of flashlights, illuminated signs, or the like and a second circular polarizing filter 2106 that is also not associated with a vehicle, such as a window of a barrier, a hood, a face shield, or the like.

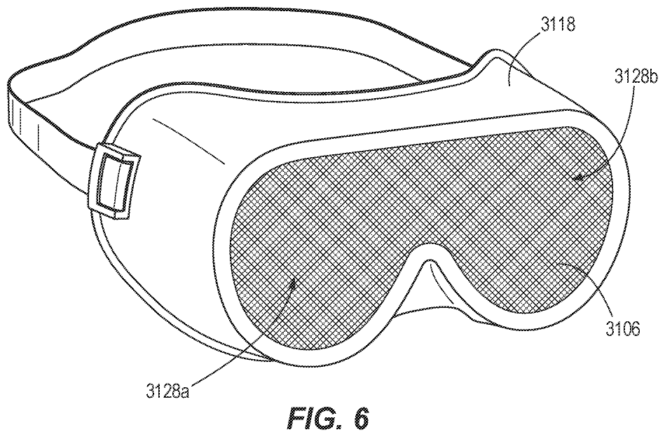

With reference to FIG. 6, a pair of goggles 3118 are shown for use with yet another embodiment of a glare reduction system. The pair of goggles 3118 may replace the glasses 118 in the glare reduction system 100 of FIG. 1, the windshield 1126 in the glare reduction system 1100 of FIG. 4, or the like. The pair of goggles 3118 are but one example of an article of personal protection equipment to be worn by a user. Other examples may instead include a face mask, a hood, a barrier, or the like. In any case, the goggles 3118 illustrate that it is possible for a user to have both eyes covered with a single second circular polarizing filter 3106. Specifically, the goggles 3118 include a first eye section 3128a and a second eye section 3128b. As shown in FIG. 6, both the first eye section 3128a and the second eye section 3128b are integrally formed as a single eye shield. Stated another way, the goggles 3118 include a single, continuous area of the second circular polarizing filter 3106 that is configured to cover both eyes of a user.

Various features of the disclosure are set forth in the following claims.

What is claimed is:

1. A glare reduction system comprising:
a light source;
a first circular polarizing filter positioned to receive light from the light source and configured to pass light that is polarized in a first circular direction; and
a pair of second circular polarizing filters, the second circular polarizing filters including respective portions positioned laterally from one other, the pair of second circular polarizing filters located a distance from the first circular polarizing filter, each of the pair of second circular polarizing filters configured to pass light that is polarized in a second circular direction, the second circular direction being opposite the first circular direction.

2. The glare reduction system of claim 1, wherein the first circular polarizing filter is coupled to the light source.

3. The glare reduction system of claim 1, wherein each of the pair of second circular polarizing filters is coupled to a glasses frame.

4. The glare reduction system of claim 3, wherein each of the pair of second circular polarizing filters is coupled to a respective lens of the glasses frame.

5. The glare reduction system of claim 4, wherein each of the pair of second circular polarizing filters is disposed within the respective lens of the glasses frame.

6. The glare reduction system of claim 1, wherein the light source includes an array of light-emitting diodes.

7. The glare reduction system of claim 1, wherein the second circular polarizing filters are spaced laterally from one another such that they do not overlap one another.

8. A glare reduction system comprising:
a pair of light sources positioned laterally from each other;
a pair of first circular polarizing filters, the first circular polarizing filters including respective portions positioned laterally from one another, each of the pair of first circular polarizing filters positioned to receive light from a respective one of the pair of light sources, each of the pair of first circular polarizing filters configured to pass light that is polarized in a first circular direction; and
a second circular polarizing filter located a distance from the pair of first circular polarizing filters, the second circular polarizing filter configured to pass light that is polarized in a second circular direction, the second circular direction being opposite the first circular direction.

9. The glare reduction system of claim 8, wherein each of the pair of light sources is coupled to a vehicle.

10. The glare reduction system of claim 9, wherein each of the pair of light sources includes a headlight.

11. The glare reduction system of claim 8, wherein the second circular polarizing filter is coupled to a vehicle.

12. The glare reduction system of claim 11, wherein the second circular polarizing filter is coupled to a windshield of the vehicle.

13. The glare reduction system of claim 12, wherein the second circular polarizing filter is disposed within the windshield.

14. The glare reduction system of claim 8, wherein each of the pair of first circular polarizing filters is coupled to the respective one of the pair of light sources.

15. The glare reduction system of claim 8, wherein the first circular polarizing filters are spaced laterally from one another such that they do not overlap one another.

16. The glare reduction system of claim 8, wherein the second circular polarizing filter is coupled to an article of personal protection equipment.

17. The glare reduction system of claim 16, wherein the article of personal protection equipment includes a pair of goggles.

18. A glare reduction system comprising:
a vehicle including a pair of headlights and a windshield;
a pair of first circular polarizing filters, each of the pair of first circular polarizing filters positioned to receive light from a respective one of the headlights, each of the pair of first circular polarizing filters configured to pass light that is polarized in a first circular direction; and
a second circular polarizing filter positioned over the windshield, the second circular polarizing filter configured to pass light that is polarized in a second circular direction, the second circular direction being opposite the first circular direction.

19. The glare reduction system of claim 18, wherein each of the pair of first circular polarizing filters is coupled to the respective one of the headlights.

20. The glare reduction system of claim 18, wherein the second circular polarizing filter is coupled to a frame of the vehicle.

21. The glare reduction system of claim 18, wherein the second circular polarizing filter is coupled to the windshield.

22. The glare reduction system of claim 18, wherein the second circular polarizing filter is disposed within the windshield.

23. A glare reduction system comprising:
a light source;
a first circular polarizing filter positioned to receive light from the light source and configured to pass light that is polarized in a first circular direction; and
an eye shield including a first eye section and a second eye section, the eye shield including a second circular polarizing filter disposed over both the first eye section and the second eye section, the second circular polarizing filter configured to pass light that is polarized in a second circular direction, the second circular direction being opposite the first circular direction.

24. The glare reduction system of claim 23, wherein the first circular polarizing filter is coupled to the light source.

25. The glare reduction system of claim 23, wherein the eye shield is coupled to a glasses frame.

26. The glare reduction system of claim 23, wherein the eye shield is coupled to a goggles frame.
